(19) United States
(12) Patent Application Publication
(10) Pub. No.: US 2010/0070589 A1
(43) Pub. Date: Mar. 18, 2010

(54) INTELLIGENTLY ANTICIPATING AND/OR PRIORITIZING EVENTS ASSOCIATED WITH A WIRELESS CLIENT

(75) Inventors: Vernon Shaw, Kirkland, WA (US); Robert Z. Evora, Douglasville, GA (US)

Correspondence Address: AT&T Legal Department - T&W;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/212,245

(22) Filed: Sep. 17, 2008

(51) Int. Cl. G06F 15/173; G06F 15/16

(52) U.S. Cl. 709/206; 709/224

(57) ABSTRACT

The claimed subject matter relates to an architecture that can anticipate relevant events associated with a profile derived from a wireless service account provision. In addition, the architecture can provide one or more recommendation for confronting the event, and further prioritize both the event and the associated recommendation(s). In an aspect of the disclosed subject matter, the priority ascribed to a particular event (or recommendation associated therewith) can be dependent upon the unique profile of the client and can further be dependent upon other contemporaneous events.

### TECHNICAL FIELD

The present application relates generally to monitoring a profile associated with a wireless communications service client, and more specifically to intelligently anticipating and/or prioritizing events in connection with the profile for said client.

### BACKGROUND

In recent times, wireless communication service providers have begun utilizing pop-up messages as a means of contacting customers. Unfortunately, these pop-ups are often random or arbitrary both in terms of content and timing. For example, the majority of pop-ups delivered to a customer relate to commercial advertisements that are likely to be of use to the customer. Typically, an advertiser pays the service provider to deliver these pop-up ads without any regard to the desires or interests of the customer. Accordingly, the customer often becomes the recipient of unsolicited and undesired advertisements that have little or no relevance to the profile of the customer.

Moreover, since these pop-ups do not consider the customer, his or her current activities or state are also not considered. Accordingly, conventional pop-ups can arrive at any time, often interrupting an activity, occluding some portion of a display, or occurring at an otherwise inopportune time. Hence, conventional pop-ups are largely ineffective for most objectives and commonly lead to aggravation on the part of the customer.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can anticipate relevant events associated with a client. In addition, the architecture can determine or infer recommendations for handling the events and/or can further prioritize both the events and the recommendations. In accordance therewith and to other related ends, the architecture can monitor in real time a profile associated with a client of a wireless service. Based at least upon the profile, and in some aspects further based upon monitored external events/activities, the architecture can generate an event associated with the client.

Moreover, the architecture can examine the incoming event in connection with the profile in order to determine one or more suggested course of action in response to the event. The suggested courses of action can be the aforementioned recommendations. The architecture can then calculate a priority for the event and the associated recommendations based upon the profile, wherein the priority can relate to a relevance or importance to the client and/or user thereof

In an aspect, the architecture can recalculate the priority for the event and the recommendations associated with that event upon receipt of a second event. In other words, a second event can change a previously calculated priority even when no change to the profile occurs. In this manner, the architecture can aid in optimizing tasks by combining or concatenating events or recommendations.

Furthermore, once prioritized, the events or recommendations can be scheduled based upon their priority, and pop-up messages can be constructed and delivered according to the schedule to a display of the client device as a pop-up. In other cases, the message can be delivered in Short Message Service (SMS) format, while in still other cases, the message can be provided in audio or verbal form, such as an “audio pop-up.” Simple and convenient feedback opportunities can be provide to allow for selection of recommendations or give relevance-based feedback in connection with events or recommendations, which can be employed to refine machine learning techniques that can be employed for various aspects of the architecture.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system that can anticipate and/or prioritize relevant events in a wireless communication environment.

FIG. 2 illustrates a block diagram of various examples of data included in profile 104.

FIG. 3 depicts a block diagram that illustrates updating priorities associated with one event based upon a second event.

FIG. 4 illustrates a block diagram of a system that can populate a message schedule based upon event priorities.

FIG. 5 is a block diagram of a system that can support or solicit client feedback.

FIG. 6 illustrates a block diagram of a system that can perform or aid with various determinations or inferences

FIG. 7 is an exemplary flow chart of procedures that define a method for anticipating or prioritizing relevant events in a wireless communication environment.

FIG. 8 is an exemplary flow chart of procedures that define a method for recalculating priority of events and/or recommendations.

FIG. 9 depicts an exemplary flow chart of procedures defining a method for providing additional features associated with prioritizing an event and/or scheduling or delivering information associated with the event.

FIG. 10 illustrates a block diagram of a computer operable to execute the disclosed architecture.

FIG. 11 illustrates an example networking environment that can effectuate mobile communication and can facilitate data transfer applications in accord with various aspects of the subject disclosure.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

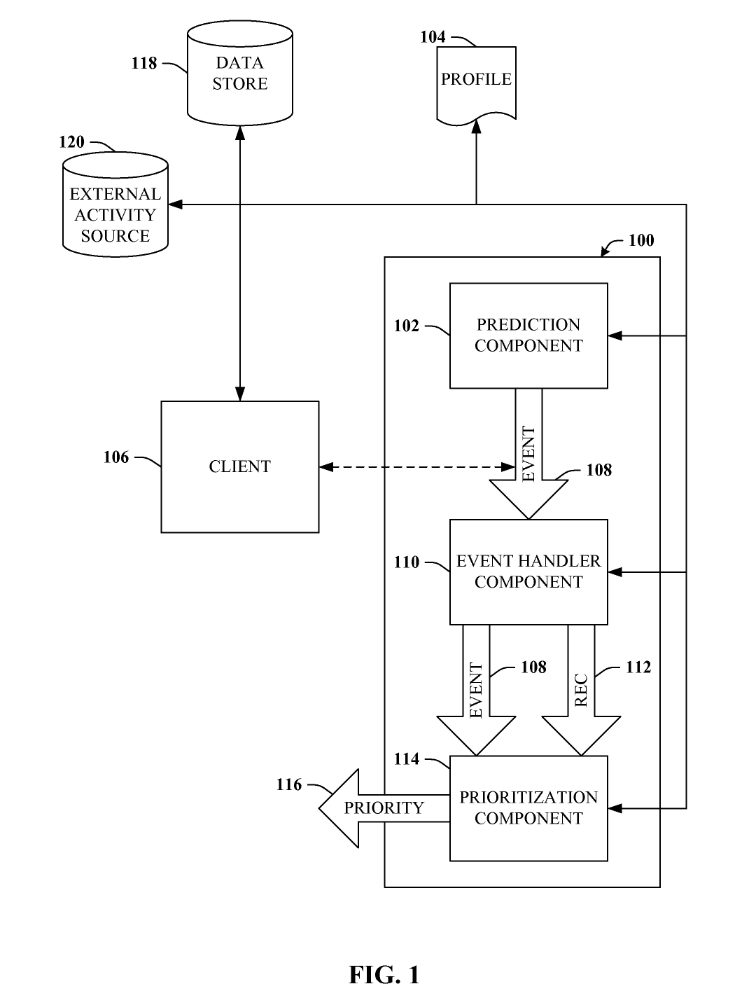

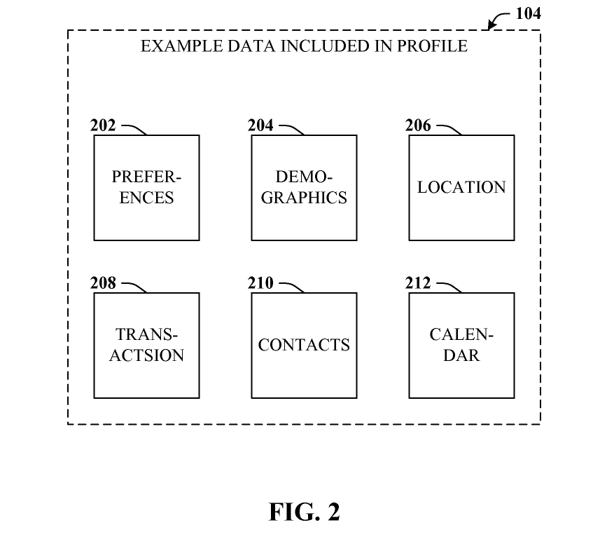

Referring now to the drawing, with reference initially to FIG. 1, system 100 that can anticipate and/or prioritize relevant events in a wireless communication environment is depicted. Generally, system 100 can include prediction component 102 that can monitor in real time subscriber profile 104, which can be associated with a subscriber to a wireless communication service, client 106. Profile 104 is typically related to or constructed from a wireless service operator provision. Profile 104 can include a variety of information relating to client 106, many examples of which are provided infra with reference to FIG. 2.

In addition, prediction component 102 can generate event 108 associated with client 106 based at least in part upon profile 104. For example, by monitoring profile 104, prediction component 102 can identify, determine, or infer event 108 (e.g., a particular state, situation, occasion, or incident) that is potentially relevant to client 106, as further detailed herein. Client 106 can be a mobile phone as well as substantially any portable electronic device suitable for wireless service provisions, such as a laptop, a tablet, a media player/recorder, a personal digital assistant (PDA), a camera, a credit card, a game, a fob, and so on. Client 106 can be a handheld device as well as wearable device and generally includes suitable hardware for one or more types of wireless communication such as cellular, wireless fidelity or “Wi-Fi” (IEEE 802.11x specifications), Bluetooth (IEEE 802.15.x specifications), Near Field Communication (NFC), Radio Frequency Identification (RFID), infrared, etc.

Additionally, system 100 can include event handler component 110 that can examine event 108 and profile 104. Based upon such examination, event handler component can determine one or more recommendation 112, wherein recommendation 112 relates to a suggested course of action in response to event 108. Accordingly, recommendation 112 is generally intended to benefit client 106 (or a user thereof) by, e.g., mitigating disruptive events 108, alerting client 106 (or the user) of potential unknowns or oversights, optimizing resolution of events 108, and so forth.

System 100 can further include prioritization component 114 that can receive event 108 as well as the one or more recommendation 112 associated with event 108. Generally, prioritization component 114, like numerous other components described herein, will also have access to profile 104. Based upon data included in profile 104, prioritization component 114 can determine or infer priority 116 for event 108 as well as that for the (one or more) recommendation 112. Prioritization component 114 can determine priority 116 in a manner consistent with identifying or inferring an importance or relevance of the associated event 108 or recommendation 112 vis-à-vis client 106. Therefore, it can be beneficial to examine profile 104 in more detail.

While still referencing FIG. 1, but referring now also to FIG. 2, various examples of data included in profile 104 are explicitly presented. As detailed supra, profile 104 can be associated with client 106 and can be utilized in numerous ways. For example, profile 104 can be utilized in order to identify or anticipate potential needs, desires, conveniences, and/or events 108 associated with client 106 as well as to prioritize such identified or anticipated events 108. Thus, as an initial example, profile 104 can include preferences 202, which can relate to settings input by client 106 or inferred from historic behavior or other portions of profile 104. For example, preferences 202 can relate to likes, dislikes, interests, behavioral or transactional patterns and so forth. Preferences 202 can also relate to individualized aspects of a user of client 106, such as speech recognition dictionaries, handwriting or notational dictionaries or even health or biometric information, portions of which can be determined in real time.

Demographic data 204 can also be included in profile 104 such as age, gender, job title, income, as well as hobbies, interests, or viewpoints. Some demographic data 306 can be received by an interface operatively coupled to client 106, which can be input by a user thereof or acquired in another manner. Furthermore, as with preference 202, some demographic data 204 can be inferred. For example, inferences relating to demographic data can be determined from location 206 or transaction 208 histories, e.g. by examining, items purchased, price paid, vendors patronized, etc.

Generally, location 206 of client 106 can be determined by way of Global Positioning System (GPS). Additionally, or alternatively, location 206 can be established by way of a Wireless Application Protocol (WAP). For instance, radiolocation and/or trilateration employing signal strength measures at various stationary transceivers by well-known means can be employed to pinpoint the location of the client 106. Other aspect can also exist such as interfacing with stationary terminals at known locations by way of RFID or NFC. Appreciably, location 206 can be sampled over time to determine travel direction, rate of travel, path of travel, points of rest, duration of rest, or the like. Appreciably, as location 206 changes, profile 104 can be updated accordingly in real time.

Profile 104 can further include transactions 208, which can include substantially any commercial transaction (e.g., purchase of a good or service) or communication transaction (e.g., call, message, chat, or email). Likewise, profile 104 can also include a list of contacts 210 as well as a schedule or calendar 212. Contacts 210 can include contact credentials (e.g., phone numbers, addresses, email addresses, IP addresses . . . ) or identification for friends, family, colleagues, acquaintances, and so forth. Contacts 210 can be classified in substantially any manner by client 106 and can also be weighted or categorized based upon frequency of contact, association, or other relationships. Appreciably, all or portions of data included in profile 104 can be actively managed and maintained by client 106 or the associated provisioner or imported from other sources, such as by way of disparate services employed by a user of client 106.

Continuing the discussion of FIG. 1, it should be appreciated that prediction component 102 can further monitor external activities and therefore employ such external activities for generating event 108. External activities can be obtained from substantially any external activity source 120 (potentially including those not subscribed to by client 106) such as, e.g., news sources (e.g., traffic, weather, financial), blogs or Really Simple Syndication (RSS) feeds (e.g., originating from contacts 210), bulletins or alerts or the like.

System 100 can also include or be operatively connected to data store 118. Data store 118 is intended to be a repository of all or portions of data, data sets, or information described herein or otherwise suitable for use with the claimed subject matter. Thus, although depicted as distinct components data store 118 can include all or portions of profile 104 or relevant information obtained from external activity source 120. Data store 118 can be centralized, either remotely or locally cached, or distributed, potentially across multiple devices and/or schemas. Furthermore, data store 118 can be embodied as substantially any type of memory, including but not limited to volatile or non-volatile, sequential access, structured access, or random access and so on. It should be understood that all or portions of data store 118 can be included in system 100, or can reside in part or entirely remotely from system 100.

In order to provide additional context, consider the following scenario, which is intended to represent a concrete illustration of the subject matter disclosed herein, but not necessarily intended to limit the claimed subject matter to those examples, scenarios, or illustrations provided herein. Ashley and Ross both subscribe to a wireless carrier that implements portions of the claimed subject matter, and both work at ABC, Inc., Ashley as a high-level executive and Ross as a mid-level engineer. Further suppose that an emergency occurs at one of ABC's manufacturing plants, which can be determined from external activity source 120 (e.g., news) or from profile 104 (e.g., transaction 208 that includes a company email describing the emergency). Prediction component 102 can generate event 108 that relates to the emergency. Event handler component 110 can determine one or more recommendation 112, and prioritization component 114 can assign priority 116 to each of these elements. For example, for Ashley, the recommendation 112 can be to contact parties where the emergency occurred or visit the site. For Ross, the recommendation 112 can be to study the schematics or other data to determine a fault cause.

While the nature of the event can be assigned different priorities for Ashley and Ross, the current situation or state of the individuals can also affect priority 116. For example, consider that Ashley is in an important executive meeting, which can be determined or inferred from her profile 104 by, e.g. calendar 212 (e.g., scheduled meeting), contacts 210 (e.g., close proximity to high-level contacts), location 206 (e.g., situated in a conference room), preferences 202 (e.g., phone set to silent), or combinations thereof, or based upon a direct input from Ashley.

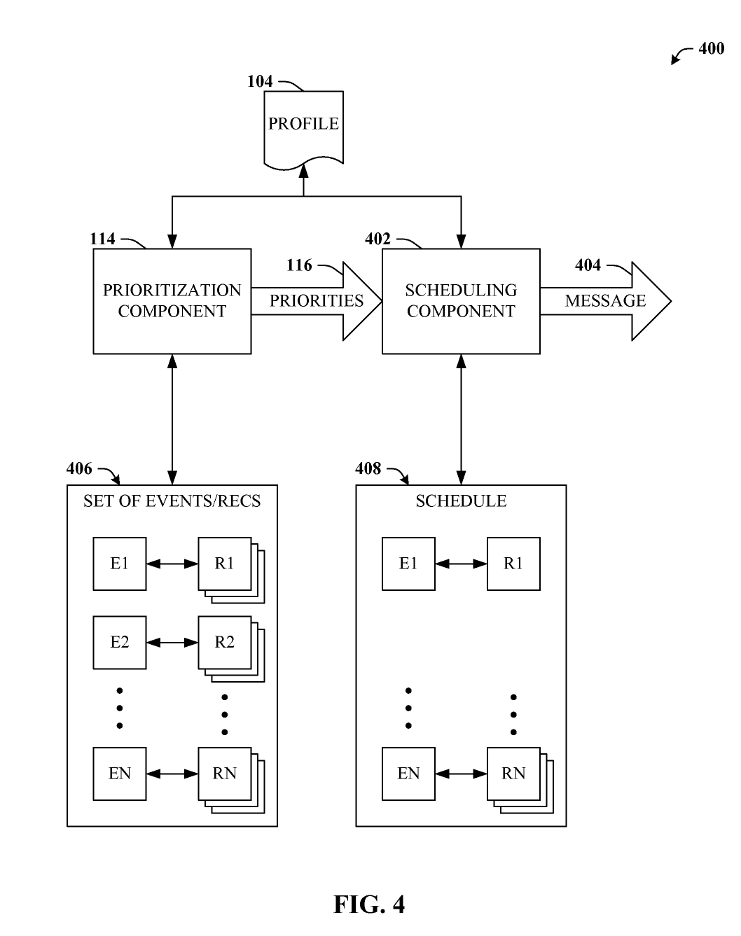

In contrast, Ross is waiting in line at the cafeteria, which can be determined or inferred from transaction 208 (e.g. swiped ID, paid, passed a turnstile), location 206 (e.g., in cafeteria with trajectory consistent with standing in line), preferences 202 (e.g., historic behavior consistent with eating lunch at the current time of day, reverting phone from silent to ring), or combinations thereof. As will be discussed in more detail in connection with FIG. 4, one object of determining priority 116 can be to schedule messages relating to event 108, which can in some aspects be provided as pop-up messages. Hence, it should be appreciated that priority 116 can be calculated independently of the current state of client 106, with the state of the client profile affecting a priority threshold necessary for activating the message. However, in other cases, the priority threshold for asserting a message can remain largely constant, with the state functioning to under- or overweight priority 116.

Regardless, it is readily apparent that given the above scenario, priority 116 for the manufacturing emergency will typically be higher for Ashley than for Ross. However, it is equally apparent that Ross's current state is much more conducive to receiving an associated message relating to the emergency than is Ashley. Appreciably, these and numerous other factors can be accounted for by the claimed subject matter as will become more apparent with additional discussion and examples.

Continuing the above example, but considering a slightly different scenario. In this case, Ashley is walking in a local park, engaged in her usual Saturday morning routine. Based upon her profile 104, and in particular, contacts 210 and location 206, prediction component 114 determines that Ashley's routine walk will bring her in close proximity to Debbie, a childhood friend with whom Ashley has not communicated with for some time. Ashley can be apprised of this information (further detailed in connection with FIG. 4) and decide whether she wants to make a slight diversion to find Debbie, who is watching a game at one of the many soccer fields in the area. It should be appreciated that for privacy reasons, Debbie can be required to allow her location information to be shared to Ashley. This can be accomplished conveniently, in a manner similar to well-known Internet-based communication tools that provide on-line presence information, but also allow the user to hide presence information, potentially based in the aggregate or for certain contacts.

As another example, consider the case in which a user (Ross) of client 106 is returning home from work. Prediction component 102 determines that along the usual path toward home (e.g., obtained from profile 104 data), there is high traffic congestion as a particular intersection due to an accident (e.g., obtained from external activity source 120). Thus, prediction component 102 generates event 108 that indicates client 106 is approaching a highly congested area. Event handler component 110 examines event 108 and determines three recommendations 112: (1) re-route to avoid the congestion; (2) stay on course in spite of the congestion; or (3) wait or engage in another activity until the congestion has moderated. Prioritization component 114 assign priority 116 to each of these recommendations 112 (as well as to event 108) based upon profile 104.

For instance, if it is determined that re-routing will provide a congestion-free course home, yet, due to increased travel distance, is estimated to take longer than wading through the congestion, then the second recommendation 112 can be assigned a higher priority 116 than the first recommendation 112. In that case, there may be no need to disclose event 108, as entering the congestion is still the quickest way home; hence event 108 can be assigned a low priority 116 as well. On the other hand, suppose Ross's profile 104 indicates a strong dislike for congestion and/or that Ross prefers driving in stress-free environments even if it is farther or takes longer. In that case, the first recommendation 112, to re-route, as well as event 108, can be assigned a higher priority 116 than the second recommendation 112.

Additionally or alternatively, suppose that according to Ashley's profile 104, it is known that Ashley enjoys coffee and often stops for coffee and a bagel on the way home from work. In this case, event handler 110 can identify a coffee shop at a location preceding the congestion and recommend a brief stop, after which it is estimated that the congestion will have cleared. For Ashley, prioritization component 114 can assign this option a higher priority 116 than for, say, Ross, who is not a fan of coffee or bagels. Furthermore, an advertisement or coupon can be located for the particular coffee shop (e.g., from external activity source 120), which can also affect priority 116.

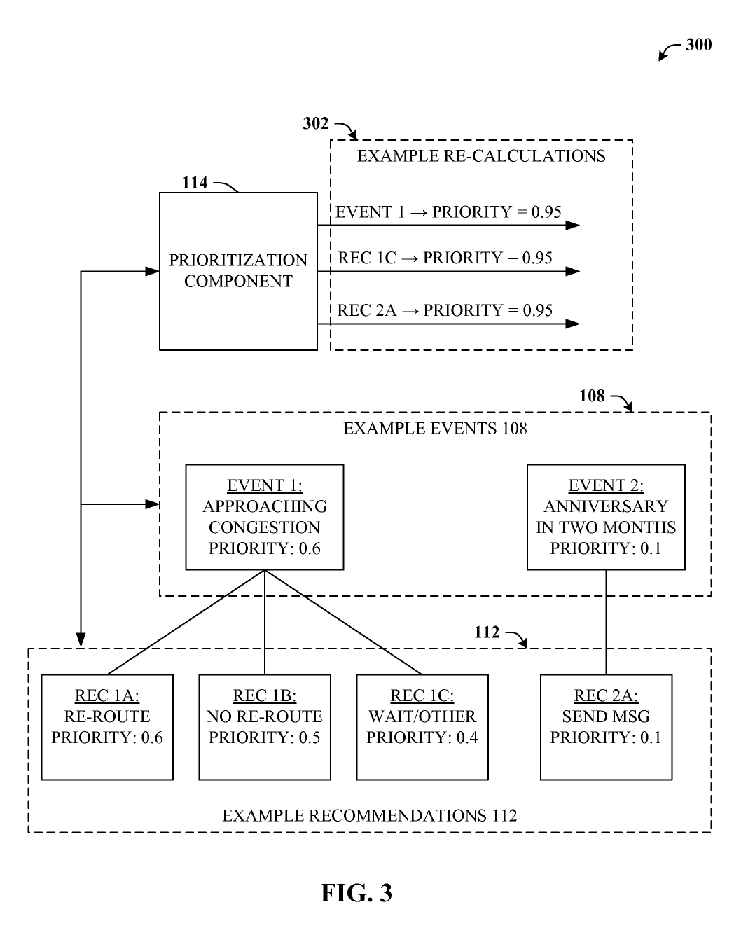

It is readily apparent from the above illustrations that information included in profile 104 can actively and in some cases dramatically affect priority 116. However, it should also be understood that other events can affect priority 116 as well. For example, in an aspect of the disclosed subject matter, prioritization component 114 can recalculate priority 116 for a first event and associated recommendations when a second event is received. These and other aspects can be better emphasized with reference to FIG. 3.

Turning now to FIG. 3, system 300 illustrates updating priorities associated with one event based upon a second event. In particular, consider event 1 which relates to approaching traffic congestion, with associated recommendations similar to those described in the example, supra, namely, recommendation 1A to re-route; recommendation 1B to continue in spite of congestion; and recommendation 1C to wait or engage in a side stop. Event 2 relates to a wedding anniversary. For example, suppose client 106 is operated by Ross from the previous scenarios, whose wedding anniversary will occur in two months time. This event can be obtained from the calendar portion (e.g., calendar 212) of the profile or from some other source. Event handler 110 has determined that a suitable recommendation 112 is to send a message reminding Ross to purchase an anniversary gift. Appreciably, it should be understood that in some aspects, suggestions can also be made as to the type of gift, based upon, e.g., anniversary or etiquette databases, prior anniversary gifts, or any other suitable information available.

However, given that Ross has been particular busy of late, and that the anniversary is still months away, prioritization component 114 has assigned event 2 and recommendation 2A a relatively low priority (e.g. 0.1). However, with regard to event 1 (considered alone), since it is known that Ross dislikes congestion and also dislikes or rarely ever stops when commuting, recommendation 1A is assigned a higher priority than recommendations 1B or 1C. However, when considered in tandem with event 2, event 1 can provide an ideal time provide deal with event 2. For example, prioritization component 114 can reason or infer that shopping for a wedding gift, something Ross's profile indicates is not relatively desirable, can occur while the congestion is sorted out, leaving Ross a congestion-free trip home after the purchase of the wedding gift. Naturally, event handler component 110 can identify a shopping mall or other venue along or near Ross's route and prior to the congestion as well as other suitable information (e.g., sales, coupons, gift suggestions . . . ), any of which can be prioritized appropriately by prioritization component 114. Thus, prioritization component 114 can recalculate elements associated with the event 1 and/or event 2 as depicted by example recalculations 302. Of particular interest is that prioritization component 114 now assigns much higher priority 116 to recommendation 1C and recommendation 2A than when the two associated events are considered independently.

By extension, it is readily apparent that numerous other events can be considered as well, perhaps recursively recalculating priorities for each new or different event. In other words, prioritization component 114 can receive a set of events 108 and associated recommendation(s) 112, and can determine priority 116 for each member of the set (e.g., events 108 and recommendations 112) further based upon one or more disparate event 108 included in the set. For example, continuing the previous example, suppose event 1 occurs on a Thursday, in which Ross normally goes straight home from work to relax. In that case, priorities 116 can be set just as described. However, if event 1 occurs on a Friday, one of the days Ross generally picks up the kids from band practice (e.g., event 3), then there may not be enough time to shop for the wedding gift while congestion is unwinding before picking up the kids. Thus, event 3 can also obtain a very high priority 116 and/or events 1 and 2 (and associated recommendations) might not be so highly prioritized. Accordingly, recommendation 1B, to slowly pass through the congestion might be the best solution in order to allow Ross to arrive on time to retrieve the kids. To mitigate even this situation, event handler component 110 can suggest that Ross contact his wife or another relative to get the kids, freeing him up to shop for the wedding gift. An automatic message can even be generated on Ross's behalf to his wife or another contact requesting suitable that she pick up the children today. Additionally or alternatively, a message can be automatically delivered to Ross's children, indicated that he, Ross, will be a bit late to pick them up, either due to traffic or the shopping. Upon a response to one or more of the above messages (e.g., Ross's wife can get the kids, or the children do not mind waiting a bit longer than usual), all priorities can again be recalculated.

Referring now to FIG. 4, system 400 that can populate a message schedule based upon event priorities is provided. In general, system 400 can include prioritization component 114 determine, based upon profile 104, priorities 116 for set 406 of events (e.g., events 108) and associated recommendations (e.g., recommendation(s) 112), as substantially described supra. In addition, although not depicted, system 400 can, of course, include prediction component 102 and event handler component 110.

In addition, system 400 can further include scheduling component 402 that can schedule message 404 for event 108 included in set 406. Message 404 can be based upon priority 116 for that event 108. For example, priorities can be categorized based upon various thresholds. For instance, at or above a very high priority threshold can qualify an event (or associated recommendation) as “emergency” or “extremely urgent.” In those cases, message 404 can be instantly delivered to client 106. At lower levels of priority, the event (and/or recommendation) can be scheduled for later delivery to client 106, potentially at more convenient or optimal times. Thus, this class of events can be included in schedule 408 for later dissemination. In particular, message 404 can be transmitted to client 106 according to schedule 408, which can be immediate, or at some later time. Finally, it should be appreciated that in some cases, the event can have such a low priority that it does not even meet the minimum threshold to be scheduled, and can thus be discarded. Accordingly, as can be readily appreciated from FIG. 4, not all events or recommendations from set 406 need be included in schedule 408.

It should be appreciated that scheduling component 402 can update schedule 408 based upon profile 104. For example, changes to profile 104 or new events can cause a recalculation of priorities, which can in turn require schedule 408 to be updated commensurately. Message 404 will typically include a notification of event 108 as well as one or more recommendation 112 associated with that event 108. In some cases, message 404 can include only the recommendation 112 that received the highest priority 116, while in other cases all or several recommendations 112 can be received, allowing the user of client 106 to review all recommendations 112 and, perhaps, to select the one most preferred.

As introduced supra, message 404 will typically be provided in the form of a pop-up. Conventionally, pop-ups for mobile devices are randomly delivered by service providers and generally relate to unwanted commercial advertisements. As a result, pop-ups today serve a little more than unsolicited intrusions with no regard to a user's current activities or state. In contrast, the disclosed subject matter can determine which messages 404 are relevant to client 106 by way of priority 116, as well as timing message 404 to occur at convenient or appropriate times by way of schedule 408. It should be understood that delivering message 404 as a pop-up is merely one example, and other examples can exist. For instance, message 404 can be transmitted to client 106 according to Short Message Service (SMS) protocol, or any other suitable format or protocol.

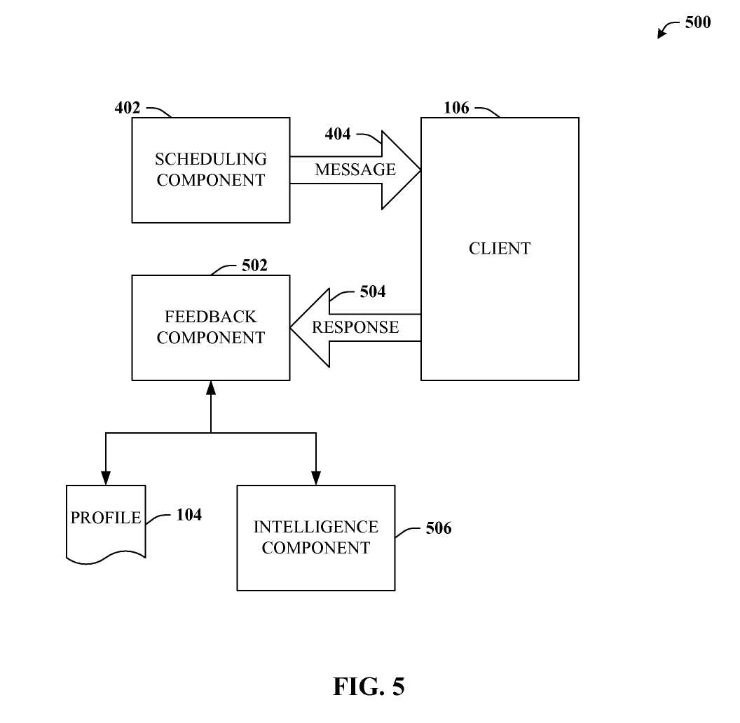

In an aspect, message 404 can be transmitted to client 106 as an “audio pop-up.” For example, many users of suitable client devices employ Bluetooth headsets. Accordingly, message 404 can be adapted to be delivered directly to such headsets or another speaker for an audio output. Revisiting one of the above scenarios, while driving home from work, Ross can receive an audio message 404 directly to his Bluetooth earpiece that “traffic congestion exists ahead at intersection X-Y” or similar. In this case, data input from Ross or other responses can be verbal as well, as is further detailed in connection with FIG. 5, infra.

With reference now to FIG. 5, system 500 that can support or solicit client feedback is depicted. System 500 typically includes scheduling component 402 that can schedule and deliver message 404 based upon priority 116, as well as all or portions of previously described components. Accordingly, given a particular priority 116, message 404 can be transmitted to client 106. As discussed previously, message 404 can include information relating to event 108 as well as one or more recommendation 112. Message 404 can further include a query relating to event 108 or recommendation 112. For example, the query can request whether “this message was useful,” or whether the client “would like to continue/discontinue receiving messages of this type,” or similar.

In other embodiments, the query can be separate from message 404, propagated as a follow-up, and can be transmitted by feedback component 502 rather than by scheduling component 402 as part of message 404. Regardless, response 504 can be received by feedback component 502. Generally, the query is designed such that response 504 can be provided in a convenient manner, such as by pressing a single key or voicing a single word so as to minimize effort on behalf of client 106. It should be appreciated that response 504 is not necessarily limited to a response to the query. For example, response 504 can relate to an input selecting between several recommendations 112 that relate to event 108, e.g. choosing one suggested course of action from among many.

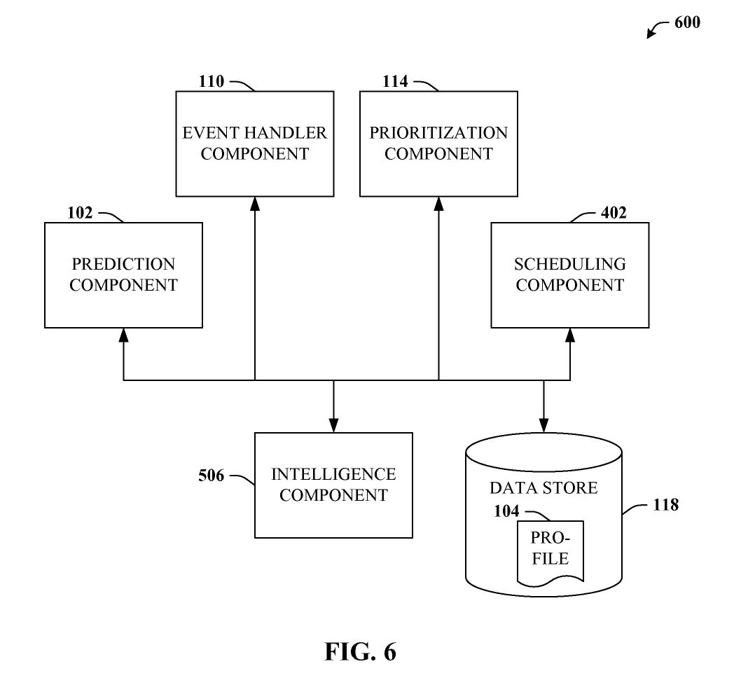

According to an aspect, feedback component 502 can utilize response 502 to update profile 104. Additionally or alternatively, feedback component 502 can utilize response 502 as an input to refine machine learning techniques associated with at least one of prediction component 102, event handler component 110, prioritization component 114, or scheduling component 402. This can be accomplished by way of intelligence component 502, which is discussed further in connection with FIG. 6.

Turning now to FIG. 6, system 600 that can perform or aid with various determinations or inferences is depicted. Typically, system 600 can include prediction component 102, event handler component 110, prioritization component 114, and scheduling component 402, which in addition to or in connection with what has been described supra, can also make various inferences or intelligent determinations. For example, prediction component 102 can employ machine learning techniques or inferences to intelligently predict potential events 108. One example can be utilization of behavioral patterns extant in profile 104 to determine appropriate or likely intersections with other data points. Likewise, event handler component 110 can make intelligent determinations or inferences. As one example, recommendation 112 typically includes an inferred action that can suitably resolve the event. In some cases this might be predetermined or selected from a list or database, but in other is can be more suitable to infer the resolution based upon unique characteristics of client 106. Next, prioritization component 114 and scheduling component 402 can also make intelligent determinations or inferences. As one example, inferring priority 116 and utilizing priority 116 to set or update schedule 408 can employ Bayesian or stochastic techniques to locate optimal data points.

In addition, system 600 can also include intelligence component 502 that can provide for or aid in various inferences or determinations. It is to be appreciated that intelligence component 502 can be operatively coupled to all or some of the aforementioned components, e.g. 102, 110, 114, and 402. Additionally or alternatively, all or portions of intelligence component 502 can be included in one or more components described herein. Moreover, intelligence component 502 will typically have access to all or portions of data sets described herein, such as data store 118, and can furthermore utilize previously determined or inferred data.

Accordingly, in order to provide for or aid in the numerous inferences described herein, intelligence component 502 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

It should be appreciated that the components described supra in FIGS. 1-6 can reside in whole or in part a mobile device such as client 106. Additionally or alternatively, all or portions of the components detailed herein can reside in a server that communicates with or provides services to mobile device clients such as client 106.

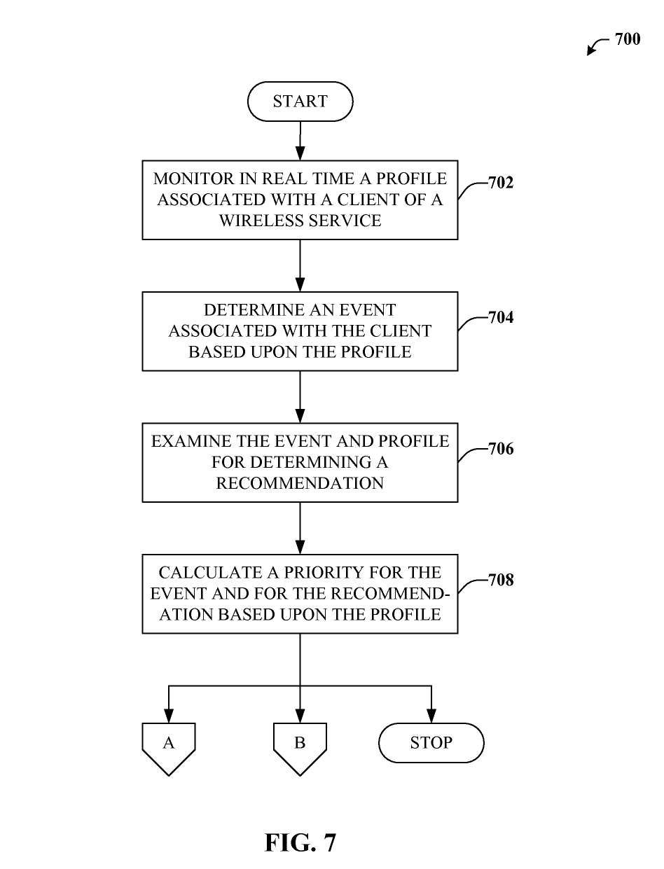

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 7, an exemplary method 700 for anticipating or prioritizing relevant events in a wireless communication environment is illustrated. Generally, at reference numeral 702, a subscriber profile associated with a client of a wireless service can be monitored in real time. Accordingly, real-time changes to the profile, such as changes in location, preferences, transactions, calendar and so forth, as well as uniform or persistent profile data can be immediately compared to other data sets.

In accordance therewith, at reference numeral 704, an event associated with the client can be determined based at least in part upon the profile. Next to be described, at reference numeral 706, the event can be examined in connection with the profile in order to determine one or more recommendation. Appreciably, the one or more recommendation can relate to a suggested course of action for responding to the event. For example, if the event is that a client's current route leads directly toward traffic congestion, the recommendation can be to re-route. Likewise, if the event is an emergency at one of the employer's manufacturing plants, then the recommendation can be to contact suitable personnel immediately. Regardless of the nature of the event, at reference numeral 708, a priority for the event can be calculated. In addition, a priority for each associated recommendation can also be calculated.

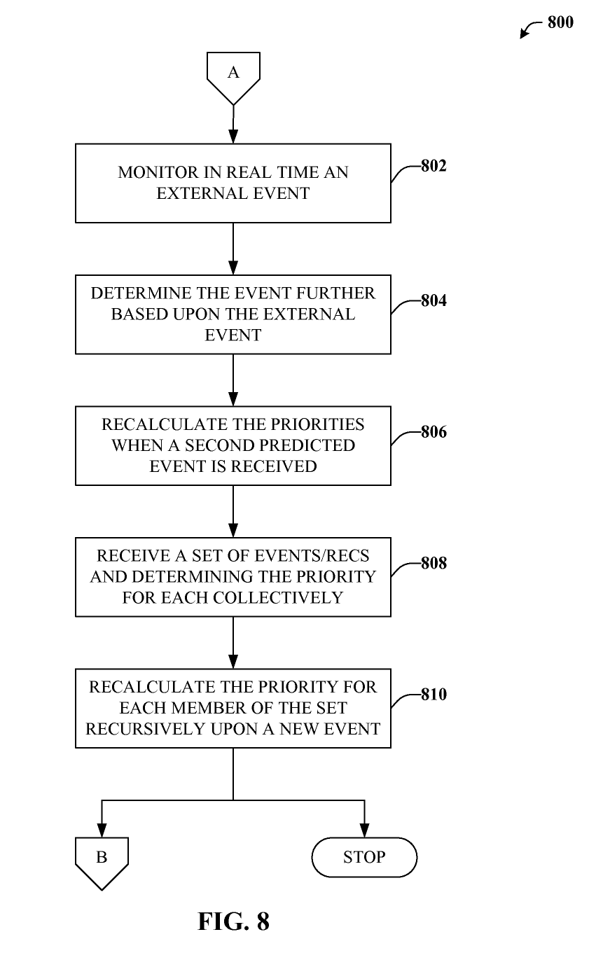

With reference now FIG. 8, an exemplary method 800 for, inter alia, recalculating priority of events and/or recommendations is provided. At reference numeral 802, an external event can be monitored in real time. The external event can be entirely independent of the profile, which is monitored at act 702 of FIG. 7. At reference numeral 804, the event described at reference numeral 704 of FIG. 7 can be further determined based upon the external event monitored at reference numeral 802.

At reference numeral 806, the priority for a first event and that for the one or more recommendations associated therewith can be recalculated when a second event is received. Similarly, at reference numeral 808, a set of events and associated recommendation(s) can be received. In addition, the priority for each member of the received set can be determined further based upon one or more disparate event included in the set. In other words, a priority for the event can be calculated not merely individually, but also in view of one or more disparate events or recommendations. Accordingly, at reference numeral 810, the priority for each member of the set can be recursively recalculated as each new or disparate event is received or examined.

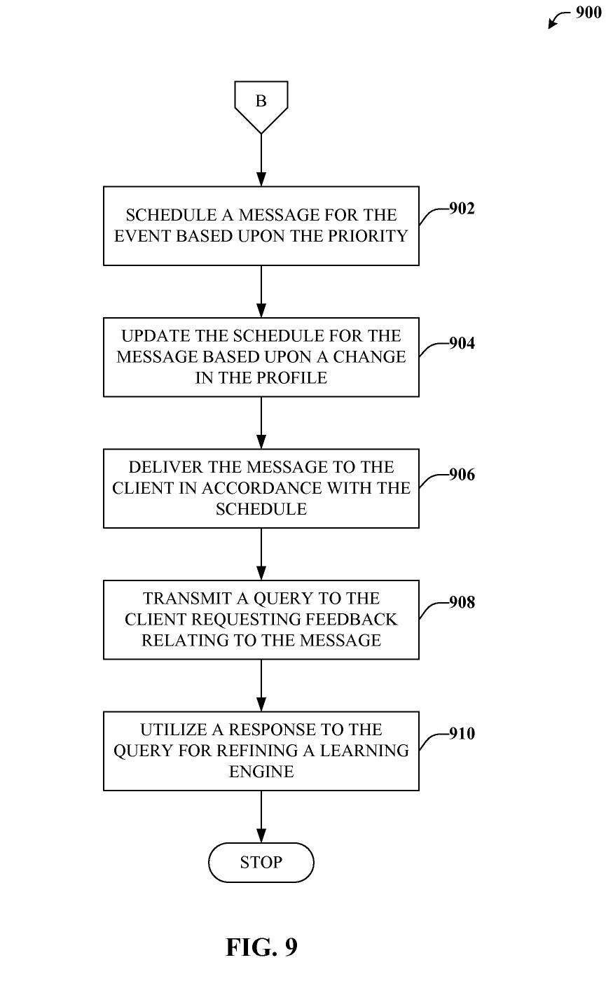

Turning briefly to FIG. 9, an exemplary method 900 for providing additional features associated with prioritizing an event and/or scheduling or delivering information associated with the event is depicted. At reference numeral 902, a message for the event can be scheduled based upon the priority determined at either reference numeral 708 or 806. The message can include a notification of the event as well as one or more recommendation for the event.

At reference numeral 904, the schedule for the message can be updated based upon a change in the profile. In addition, at reference numeral 906, the message can be delivered or propagated to the client in accordance with the schedule. For example, the schedule can determine that a message should be delivered immediately or at some later time, typically when it is believed to be most convenient or helpful to a user of the client device. It should be appreciated that the message can be delivered as a pop-up, as an audio pop-up, in SMS format, or according to some other suitable format, protocol, or container.

Furthermore, at reference numeral 908, a query can be propagated to the client requesting feedback associated with the message. Additionally or alternatively, the query can relate to a selection based upon data provided with the message, such as selecting between multiple recommendations. At reference numeral 910, a response to the query can be utilized for refining a learning engine associated with the profile.

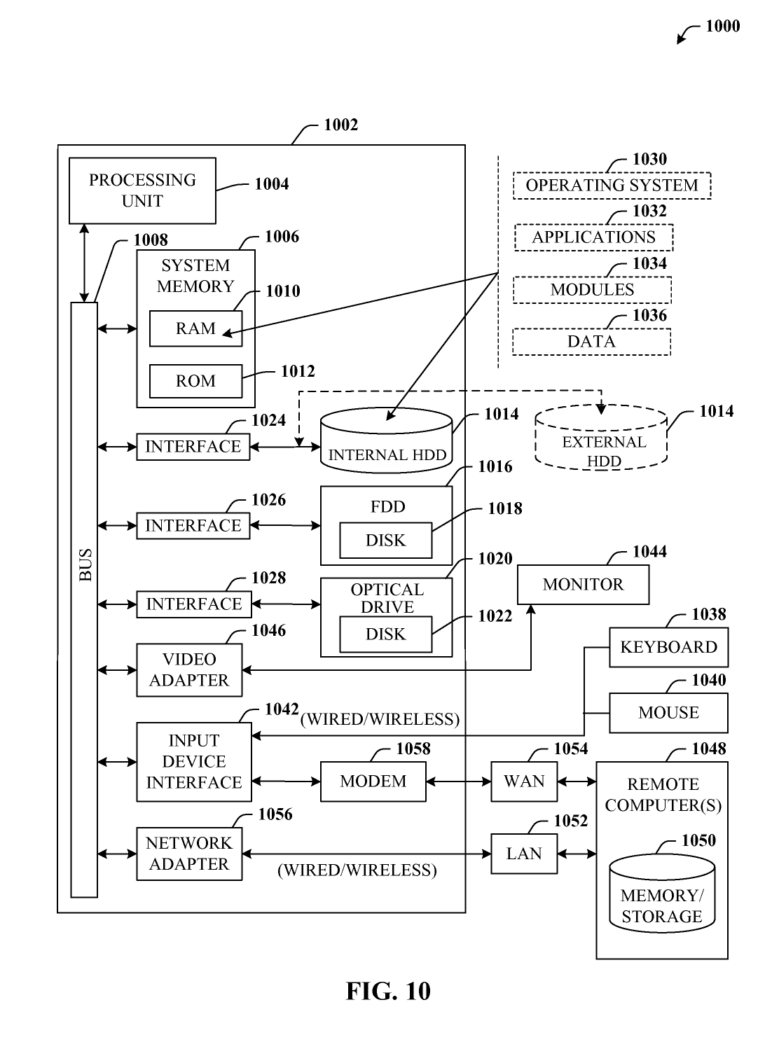

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

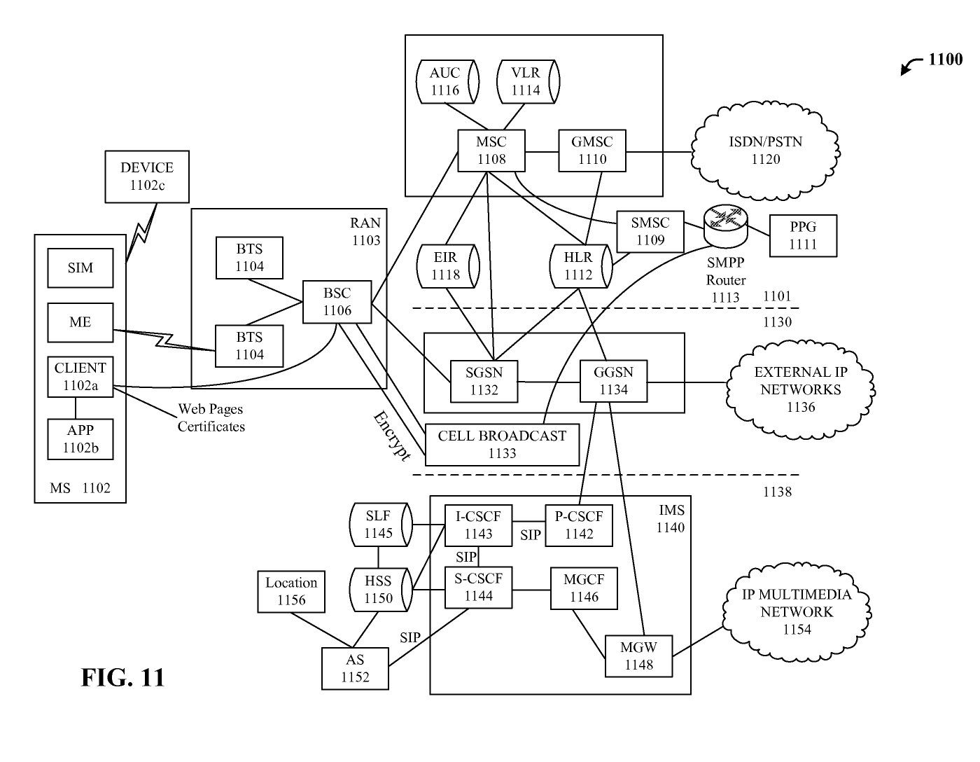

Now turning to FIG. 11, example architecture 1100 suitable for implementing all or portions of the disclosed subject matter is provided. In particular, architecture 1100 relates to a GSM/GPRS/IP multimedia network architecture 1100 that includes a GSM core network 1101, a GPRS network 1130 and an IP multimedia network 1138. The GSM core network 1101 includes a Mobile Station (MS) 1102, at least one Base Transceiver Station (BTS) 1104 and a Base Station Controller (BSC) 1106. The MS 1102 is physical equipment or Mobile Equipment (ME), such as a mobile phone or a laptop computer that is used by mobile subscribers, with a Subscriber identity Module (SIM). The SIM includes an International Mobile Subscriber Identity (IMSI), which is a unique identifier of a subscriber. The MS 1102 includes an embedded client 1102a that receives and processes messages received by the MS 1102. The embedded client 1102a can be implemented in JAVA and is discuss more fully below.

The embedded client 1102a communicates with an application 1102b that provides services and/or information to an end user. One example of the application can be navigation software that provides near real-time traffic information that is received via the embedded client 1102a to the end user. The navigation software can provide road conditions, suggest alternate routes, etc. based on the location of the MS 1102. Those of ordinary skill in the art understand that there are many different methods and systems of locating an MS 1102.

Alternatively, the MS 1102 and a device 1102c can be enabled to communicate via a short-range wireless communication link, such as BLUETOOTH. For example, a BLUETOOTH SIM Access Profile can be provided in an automobile (e.g., device 1102c) that communicates with the SIM in the MS 1102 to enable the automobile's communications system to pull information from the MS 1102. The BLUETOOTH communication system in the vehicle becomes an “embedded phone” that employs an antenna associated with the automobile. The result is improved reception of calls made in the vehicle. As one of ordinary skill in the art would recognize, an automobile is one example of the device 1102c. There can be an endless number of devices 1102c that use the SIM within the MS 1102 to provide services, information, data, audio, video, etc. to end users.

The BTS 1104 is physical equipment, such as a radio tower, that enables a radio interface to communicate with the MS. Each BTS can serve more than one MS. The BSC 1106 manages radio resources, including the BTS. The BSC can be connected to several BTSs. The BSC and BTS components, in combination, are generally referred to as a base station (BSS) or radio access network (RAN) 1103.

The GSM core network 1101 also includes a Mobile Switching Center (MSC) 1108, a Gateway Mobile Switching Center (GMSC) 1110, a Home Location Register (HLR) 1112, Visitor Location Register (VLR) 1114, an Authentication Center (AuC) 1118, and an Equipment Identity Register (EIR) 1116. The MSC 1108 performs a switching function for the network. The MSC also performs other functions, such as registration, authentication, location updating, handovers, and call routing. The GMSC 1110 provides a gateway between the GSM network and other networks, such as an Integrated Services Digital Network (ISDN) or Public Switched Telephone Networks (PSTNs) 1120. In other words, the GMSC 1110 provides interworking functionality with external networks.

The HLR 1112 is a database or component(s) that comprises administrative information regarding each subscriber registered in a corresponding GSM network. The HLR 1112 also includes the current location of each MS. The VLR 1114 is a database or component(s) that contains selected administrative information from the HLR 1112. The VLR contains information necessary for call control and provision of subscribed services for each MS currently located in a geographical area controlled by the VLR. The HLR 1112 and the VLR 1114, together with the MSC 1108, provide the call routing and roaming capabilities of GSM. The AuC 1116 provides the parameters needed for authentication and encryption functions. Such parameters allow verification of a subscriber's identity. The EIR 1118 stores security-sensitive information about the mobile equipment.

A Short Message Service Center (SMSC) 1109 allows one-to-one Short Message Service (SMS) messages to be sent to/from the MS 1102. A Push Proxy Gateway (PPG) 1111 is used to “push” (e.g., send without a synchronous request) content to the MS 1102. The PPG 1111 acts as a proxy between wired and wireless networks to facilitate pushing of data to the MS 1102. A Short Message Peer to Peer (SMPP) protocol router 1113 is provided to convert SMS-based SMPP messages to cell broadcast messages. SMPP is a protocol for exchanging SMS messages between SMS peer entities such as short message service centers. It is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1102 sends a location update including its current location information to the MSC/VLR, via the BTS 1104 and the BSC 1106. The location information is then sent to the MS's HLR. The HLR is updated with the location information received from the MSC/VLR. The location update also is performed when the MS moves to a new location area. Typically, the location update is periodically performed to update the database as location-updating events occur.

The GPRS network 1130 is logically implemented on the GSM core network architecture by introducing two packet-switching network nodes, a serving GPRS support node (SGSN) 1132, a cell broadcast and a Gateway GPRS support node (GGSN) 1134. The SGSN 1132 is at the same hierarchical level as the MSC 1108 in the GSM network. The SGSN controls the connection between the GPRS network and the MS 1102. The SGSN also keeps track of individual MS's locations and security functions and access controls.

A Cell Broadcast Center (CBC) 1133 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1134 provides a gateway between the GPRS network and a public packet network (PDN) or other IP networks 1136. That is, the GGSN provides interworking functionality with external networks, and sets up a logical link to the MS through the SGSN. When packet-switched data leaves the GPRS network, it is transferred to an external TCP-IP network 1136, such as an X.25 network or the Internet. In order to access GPRS services, the MS first attaches itself to the GPRS network by performing an attach procedure. The MS then activates a packet data protocol (PDP) context, thus activating a packet communication session between the MS. the SGSN, arc the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time. A class B MS can attach to the network for both GPRS services and GSM services simultaneously. However, a class B MS does not support simultaneous operation of the GPRS services and GSM services. That is, a class B MS can only use one of the two services at a given time. A class C MS can attach for only one of the GPRS services and GSM services at a time. Simultaneous attachment and operation of GPRS services and GSM services is not possible with a class C MS.

A GPRS network 1130 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS cannot receive pages from a circuit switched domain when engaged in a data call, since the MS is receiving data and is not listening to a paging channel. In a NOM3 network, a MS can monitor pages for a circuit switched network while received data and vise versa.

The IP multimedia network 1138 was introduced with 3GPP Release 5, and includes an IP multimedia subsystem (IMS) 1140 to provide rich multimedia services to end users. A representative set of the network entities within the IMS 1140 are a call/session control function (CSCF), a media gateway control function (MGCF) 1146, a media gateway (MGW) 1148, and a master subscriber database, called a home subscriber server (HSS) 1150. The HSS 1150 can be common to the GSM network 1101, the GPRS network 1130 as well as the IP multimedia network 1138.

The IP multimedia system 1140 is built around the call/session control function, of which there are three types: an interrogating CSCF (I-CSCF) 1143, a proxy CSCF (P-CSCF) 1142, and a serving CSCF (S-CSCF) 1144. The P-CSCF 1142 is the MS's first point of contact with the IMS 1140. The P-CSCF 1142 forwards session initiation protocol (SIP) messages received from the MS to an SIP server in a home network (and vice versa) of the MS. The P-CSCF 1142 can also modify an outgoing request according to a set of rules defined by the network operator (for example, address analysis and potential modification).

The I-CSCF 1143 forms an entrance to a home network and hides the inner topology of the home network from other networks and provides flexibility for selecting an S-CSCF. The I-CSCF 1143 can contact a subscriber location function (SLF) 1145 to determine which HSS 1150 to use for the particular subscriber, if multiple HSS's 1150 are present. The S-CSCF 1144 performs the session control services for the MS 1102. This includes routing originating sessions to external networks and routing terminating sessions to visited networks. The S-CSCF 1144 also decides whether an application server (AS) 1152 is required to receive information on an incoming SIP session request to ensure appropriate service handling. This decision is based on information received from the HSS 1150 (or other sources, such as an application server 1152). The AS 1152 also communicates to a location server 1156 (e.g., a Gateway Mobile Location Center (GMLC)) that provides a position (e.g. latitude/longitude coordinates) of the MS 1102.

The HSS 1150 contains a subscriber profile and keeps track of which core network node is currently handling the subscriber. It also supports subscriber authentication and authorization functions (AAA). In networks with more than one HSS 1150, a subscriber location function provides information on the HSS 1150 that contains the profile of a given subscriber.

The MGCF 1146 provides interworking functionality between SIP session control signaling from the IMS 1140 and ISUP/BICC call control signaling from the external GSTN networks (not shown). It also controls the media gateway (MGW) 1148 that provides user-plane interworking functionality (e.g., converting between AMR- and PCM-coded voice). The MGW 1148 also communicates with other IP multimedia networks 1154.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that anticipates or prioritizes relevant events in a wireless communication environment, comprising:
a prediction component that monitors in real time a subscriber profile associated with a client of a wireless service, and that generates an event associated with the client based at least in part upon the profile;
an event handler component that examines the event and the profile in order to determine a recommendation(s), the recommendation(s) relates to a suggested course of action in response to the event; and
a prioritization component that determines, based upon the profile, a priority for the event and for each recommendation.

2. The system of claim 1, the profile includes at least one of one or more preference associated with the client, a speech recognition dictionary associated with the client, demographic information associated with the client, one or more transaction associated with the client, a location of the client, a set of contacts associated with the client, or a calendar associated with the client.

3. The system of claim 1, the prediction component further monitors external events in order to generate the event.

4. The system of claim 1, the prioritization component recalculates the priority for a first event and associated recommendation(s) when a second event is received.

5. The system of claim 1, the prioritization component receives a set of events and associated recommendation(s) and determines the priority for each member of the set further based upon one or more disparate event included in the set.

6. The system of claim 1, further comprising a scheduling component that schedules a message for the event based upon the priority.

7. The system of claim 6, the scheduling component updates the schedule for the message based upon the profile.

8. The system of claim 6, the message includes a notification of the event or one or more recommendation for the event.

9. The system of claim 6, the message is transmitted to the client according to the schedule.

10. The system of claim 9, the message is transmitted to the client as a pop-up message.

11. The system of claim 9, the message is transmitted to the client according to short message service (SMS) protocol.

12. The system of claim 9, the message is transmitted to the client as an audio pop-up.

13. The system of claim 1, further comprising a feedback component that transmits to the client a query relating to at least one of the event or the recommendation, the query requests a feedback response.

14. The system of claim 13, the feedback response is provided by a single or a small set of keystrokes or a single word or short phrase.

15. The system of claim 13, the feedback component utilizes the feedback response to update the profile.

16. The system of claim 13, the feedback component utilizes the feedback response as an input to refine machine learning techniques associated with at least one of the prediction component, the event handler component, the prioritization component, or the scheduling component.

17. A method for anticipating or prioritizing relevant events in a wireless communication environment, comprising:
monitoring in real time a subscriber profile associated with a client of a wireless service;
determining an event associated with the client based at least in part upon the profile;
examining the event in connection with the profile for determining a recommendation, the recommendation relates to a suggested course of action for responding to the event; and
calculating a priority for the event and for the recommendation based upon the profile.

18. The method of claim 17, further comprising at least one of the following acts:
monitoring in real time an external event;
determining the event further based upon the external event;
recalculating the priority for a first event and for the recommendation associated therewith when a second event is received;
receiving a set of events and associated recommendation(s), and determining the priority for each member of the set further based upon one or more disparate event included in the set; or recalculating the priority for each member of the set recursively as each new event is received.

19. The method of claim 17, further comprising at least one of the following acts:
scheduling a message for the event based upon the priority, the message including a notification of the event or one or more recommendation for the event;
updating the schedule for the message based upon a change in the profile;
delivering the message to the client in accordance with the schedule, the message is delivered as a pop-up, as an audio pop-up, or in SMS format;
transmitting a query to the client requesting feedback associated with the message; or
utilizing a response to the query for refining a learning engine associated with the profile.

20. A system that anticipates and prioritizes relevant events in a wireless communication environment, comprising:
a prediction component that monitors in real time a subscriber profile associated with a client of a wireless service and an external event, the prediction component creates an event associated with the client based at least in part upon the profile;
an event handler component that examines the event and the profile in order to determine a recommendation, the recommendation relates to a suggested course of action in response to the event; and
a prioritization component that receives a set of recommendations, at least two of which are associated with disparate events, and that calculates a priority for each recommendation based upon a non-associated event and further based upon the profile.
